(19) United States
(12) Patent Application Publication
(10) Pub. No.: US 2018/0088366 A1
(43) Pub. Date: Mar. 29, 2018

(54) ARRAY SUBSTRATES AND LIQUID CRYSTAL PANELS

(71) Applicant: Shenzhen China Star Optoelectronics Technology Co., Ltd., Shenzhen, Guangdong (CN)

(72) Inventor: Xiangyang XU, Shenzhen, Guangdong (CN)

(73) Assignee: Shenzhen China Star Optoelectronics Technology Co., Ltd., Shenzhen, Guangdong (CN)

(21) Appl. No.: 15/110,348

(22) PCT Filed: May 27, 2016
(86) PCT No.: PCT/CN2016/083647

§ 371 Date: Jul. 7, 2016

(30) Foreign Application Priority Data
Mar. 11, 2016 (CN) 201610140366.8

(51) Int. Cl. G02F 1/13; G02F 1/1343; G02F 1/1345; G02F 1/1362; G02F 1/1368

(52) U.S. Cl. CPC G02F 1/1323; G02F 1/134336; G02F 1/13452; G02F 2201/122; G02F 1/136227; G02F 1/1368; G02F 1/136213

(57) ABSTRACT

The present disclosure relates to an array substrate and a liquid crystal panel. The array substrate includes a substrate and a plurality of first gate lines, a plurality of second gate lines, and a plurality of data lines arranged on the same side of the substrate, and a plurality of common electrode lines intersecting with the first gate lines. The first gate lines, the second gate lines, and the common electrode lines are parallel to and spaced apart from each other. The adjacent first gate lines and the second gate lines, and two adjacent data lines cooperatively define one pixel area. The pixel area is configured with a first pixel electrode and a second pixel electrode, and a first TFT and second TFT. The first/second pixel electrode and the common electrode are isolated from the first/second insulation layers.

### CROSS REFERENCE

This application claims the priority of Chinese Patent Application No. 20161014366.8, entitled “Array substrates and liquid crystal panels”, filed on Mar. 11, 2016, the disclosure of which is incorporated herein by reference in its entirety.

### FIELD OF THE INVENTION

The present invention relates to display technology field, and more particularly to an array substrate and a liquid crystal panel.

### BACKGROUND OF THE INVENTION

Liquid crystal display (LCD) is a commonly used electronic device characterized by attributes such as low power consumption, small dimension, and light weight, and thus has been widely adopted. Conventionally, the pixels within the LCD include a certain number of display fields, such that the displayable viewing angle is fixed. That is, the liquid crystal panel cannot switch between different viewing angles.

### SUMMARY OF THE INVENTION

The technical issue that the embodiment of the present invention solves is to provide a flat panel and flat panel display, achieving the resolution increase of the flat panel display in the same area.

In one aspect, an array substrate includes: a substrate and a plurality of first gate lines, a plurality of second gate lines, and a plurality of data lines arranged on the same side of the substrate, the substrate comprises a first surface, and the first gate lines are arranged on the first surface, the first gate lines extend along a first direction and spaced apart from each other along a second direction, the second gate lines are arranged on the first surface, the second gate lines extend along the first direction, and are spaced apart from each other along the second direction, each of the second gate lines is arranged between two adjacent first gate lines, the array substrate further comprises a plurality of common electrode lines on the first surface, each of the common electrode lines is arranged between adjacent first gate lines and the second gate lines, the adjacent first gate lines and the second gate lines, and two adjacent data lines cooperatively define one pixel area; the array substrate further comprises a first pixel electrode, a second pixel electrode, a first TFT, and a second TFT, the first pixel electrode is isolated from the common electrode lines by a first insulation layer, and the second pixel electrode is isolated from the first pixel electrode by a second insulation layer, a number of the display fields of the second pixel electrode is greater than the number of the display fields of the first pixel electrode, the first gate lines is arranged in the pixel area formed in a rim of the first TFT,the first TFT comprises a first gate area and a first source area, the first gate area electrically connects to the first gate lines forming the pixel area, the first source area electrically connects to the first pixel electrode, the second gate lines is arranged in the pixel area formed in the rim of the second TFT, the second TFT comprises a second gate area and a second drain area, the second gate area electrically connects to the second gate line forming the pixel area, and the second drain area electrically connects to the second pixel electrode, when a condition that the first gate lines receive the scanning signals transitions to the condition that the second gate lines receive the scanning signals, the array substrate transitions from a first viewing angle mode to a second viewing angle mode, when the condition that the second gate lines receives the scanning signals transitions to the condition that the first gate lines receives the scanning signals, the array substrate transitions from the second viewing angle mode to the first viewing angle mode, wherein the viewing angle of the first viewing angle mode is smaller than that of the second viewing angle mode.

Wherein the second pixel electrode comprises a first main branch and a second main branch, and the second main branch intersects with the first main branch to form four display fields, the second pixel electrode within each of the display fields comprises a first sub-branch, a second sub-branch, and a third sub-branch, the first sub-branch extends from the first main branch, the second sub-branch extends from an intersection of the first main branch and the first sub-branch, and the third sub-branch extends from the first sub-branch, and the first sub-branch, the second sub-branch, and the third sub-branch are parallel to each other, and are spaced apart from each other.

Wherein the first main branch and the first sub-branch are perpendicular to each other and intersect with each other, the intersection is at a middle point of the first main branch and of the first sub-branch, the first sub-branch is symmetrical to the third sub-branch with respect to the second sub-branch, a length of the second sub-branch is greater than the length of the first sub-branch, and the length of the second sub-branch is greater than the length of the third sub-branch.

Wherein the first insulation layer covers the first gate area, the second gate area, and the common electrode line, the first pixel electrode is arranged on the first insulation layer, and the first pixel electrode corresponds to the common electrode line, the first TFT further comprises a first trench layer and the first drain area, the first trench layer is arranged above the first insulation layer, the first trench layer corresponds to the first gate area, and the first trench layer and the first pixel electrode are spaced apart from each other, the first source area and the first drain area are arranged at two opposite ends of the first trench layer, and the first source area covers a portion of the first pixel electrode, and the second insulation layer covers the first source area and the first drain area.

Wherein the first TFT also comprises a first ohmic contact layer arranged between the first source area and the first trench layer, and the first ohmic contact layer is configured for reducing the contacting resistance between the first source area and the first trench layer.

Wherein the first ohmic contact layer further comprises a second ohmic contact layer arranged between the first drain area and the first trench layer, the second ohmic contact layer is configured for reducing the contacting resistance between the first drain area and the first trench layer.

Wherein the second TFT comprises a second trench layer and a second source area, the second trench layer is arranged on the first insulation layer, and the second trench layer corresponds to the second gate area, the second trench layer and the first pixel electrode are spaced apart from each other, the second source area and the second drain area are arranged at two opposite ends of the second trench layer, the second drain area and the first pixel electrode are spaced apart from each other, the second insulation layer covers the second source area and the second drain area, the second insulation layer comprises a through hole corresponding to the second drain area, and the second pixel electrode is arranged on the second insulation layer, and the second pixel electrode connects to the second drain area via the through hole.

Wherein the second TFT further comprises a third ohmic contact layer arranged between the second source area and the second trench layer, and the third ohmic contact layer is configured for reducing the contacting resistance between the second source area and the second trench layer.

Wherein the second TFT further comprises a fourth ohmic contact layer arranged between the second drain area and the second trench layer, and the fourth ohmic contact layer is configured for reducing the contacting resistance between the second drain area and the second trench layer.

In another aspect, a liquid crystal panel includes the above liquid crystal panel.

In view of the above, the array substrate 10 includes a plurality of first gate lines 120a and a plurality of second gate lines 120b. Each of the second gate lines 120b is arranged between two adjacent first gate lines 120a. The adjacent first gate lines 120a and the second gate lines 120b, and two adjacent data lines 130 cooperatively define one pixel area. On the array substrate 10, the first gate lines 120a, the second gate lines 120b, and the data lines 130 forms a plurality of pixel areas arranged in a matrix. Each of the pixel areas includes the first TFT 150 corresponding to the first gate lines 120a and a first pixel electrode 170a, and each of the pixel areas includes the second TFT 160 corresponding to the second gate lines 120b and the second pixel electrode 170b. The number of the display fields of the second pixel electrode 170b is greater than the number of the display fields of the first pixel electrode 170a. When the condition that the first gate lines 120a receive the scanning signals transitions to the condition that the second gate lines 120b receive the scanning signals, the array substrate 10 transitions from a first viewing angle mode to a second viewing angle mode. When the condition that the second gate lines 120b receives the scanning signals transitions to the condition that the first gate lines 120a receives the scanning signals, the array substrate 10 transitions from the second viewing angle mode to the first viewing angle mode, wherein the viewing angle of the first viewing angle mode is smaller than that of the second viewing angle mode. In this way, the two viewing angle modes are transitions to each other.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a top view of the array substrate in accordance with one embodiment.

FIG. 2 is an enlarged view of the first gate line, the second gate line, and the data line formed within one pixel area of FIG. 1.

FIG. 3 is a cross sectional view of the structure of FIG. 2 along the II-II line.

FIG. 4 is a schematic view of the second pixel electrode of FIG. 2.

FIG. 5 is a schematic view of the liquid crystal panel in accordance with one embodiment.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

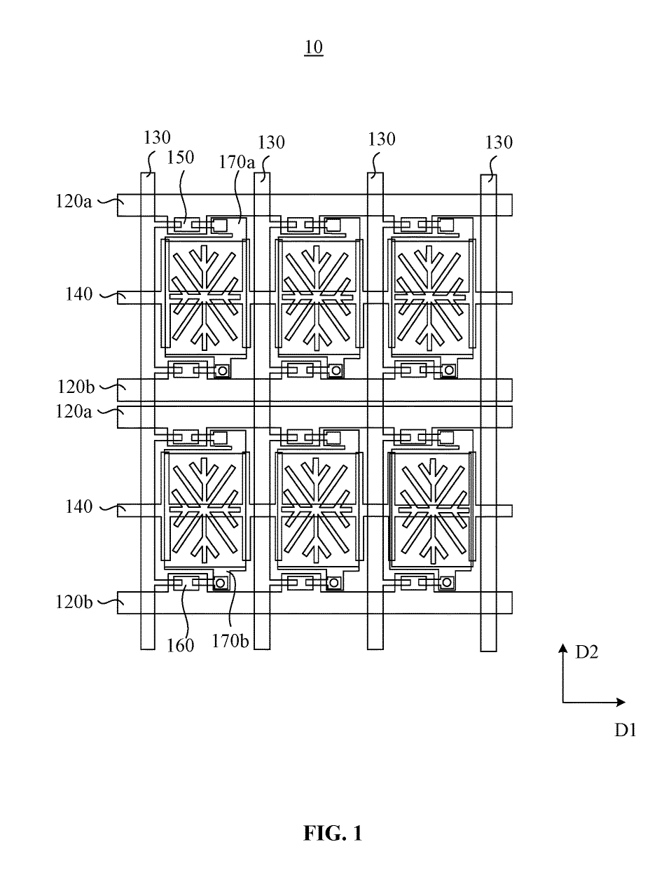

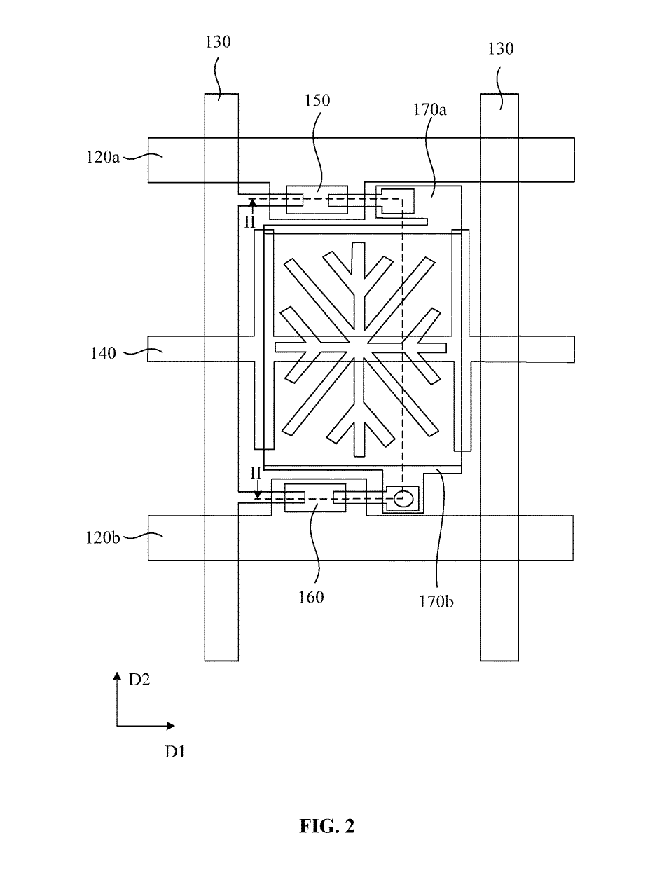

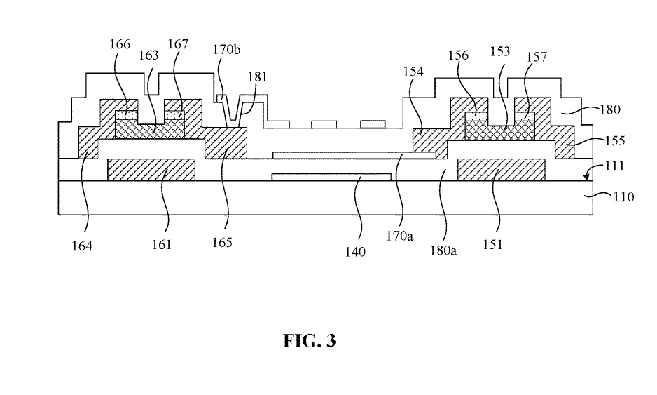

FIG. 1 is a top view of the array substrate in accordance with one embodiment. FIG. 2 is an enlarged view of the first gate line, the second gate line, and the data line formed within one pixel area of FIG. 1. FIG. 3 is a cross sectional view of the structure of FIG. 2 along the II-II line.

The array substrate 10 includes a substrate 110 and a plurality of first gate lines 120a, a plurality of second gate lines 120b, and a plurality of data lines 130. The substrate 110 includes a first surface 110a, and the first gate lines 120a are arranged on the first surface 110a. In addition, the first gate lines 120a extend along a first direction (D1) and spaced apart from each other along a second direction (D2). The second gate lines 120b are arranged on the first surface 110a. The second gate lines 120b extend along the first direction (D1), and are spaced apart from each other along the second direction (D2). In addition, each of the second gate lines 120b is arranged between two adjacent first gate lines 120a. The array substrate 10 further includes a plurality of common electrode lines 140 on the first surface 110a. Each of the common electrode lines 140 is arranged between adjacent first gate lines 120a and the second gate lines 120b. The adjacent first gate lines 120a and the second gate lines 120b, and two adjacent data lines 130 cooperatively define one pixel area. On the array substrate 10, the first gate lines 120a, the second gate lines 120b, and the data lines 130 forms a plurality of pixel areas arranged in a matrix. With respect to one pixel area, the array substrate 10 further includes a first pixel electrode 170a, a second pixel electrode 170b, a first TFT 150, and a second TFT 160. The first pixel electrode 170a is isolated from the common electrode lines 140 by a first insulation layer 180a, and the second pixel electrode 170b is isolated from the first pixel electrode 170a by a second insulation layer 180b. The number of the display fields of the second pixel electrode 170b is greater than the number of the display fields of the first pixel electrode 170a. The first gate lines 120a is arranged in the pixel area formed in a rim of the first TFT 150. The first TFT 150 includes a first gate area 151 and a first source area 154. The first gate area 151 electrically connects to the first gate lines 120a forming the pixel area. The first source area 154 electrically connects to the first pixel electrode 170a. The second gate lines 120b is arranged in the pixel area formed in the rim of to the second TFT 160. The second TFT 160 includes a second gate area 161 and a second drain area 165. The second gate area 161 electrically connects to the second gate line 120b forming the pixel area, and the second drain area 165 electrically connects the second pixel electrode 170b. When the condition that the first gate lines 120a receive the scanning signals transitions to the condition that the second gate lines 120b receive the scanning signals, the array substrate 10 transitions from a first viewing angle mode to a second viewing angle mode. When the condition that the second gate lines 120b receives the scanning signals transitions to the condition that the first gate lines 120a receives the scanning signals, the array substrate 10 transitions from the second viewing angle mode to the first viewing angle mode, wherein the viewing angle of the first viewing angle mode is smaller than that of the second viewing angle mode. The first direction (D1) may be x-axis, and the second direction (D2) may be y-axis.

Specifically, when the first gate lines 120a receives the scanning signals, the first gate area 151 of the first TFT 150 electrically connects to the first gate lines 120a, and the first drain area 155 of the first TFT 150 electrically connects to the first pixel electrode 170a. Thus, the scanning signals are loaded on the first pixel electrode 170a via the first TFT 150. At this moment, a first electrical field is formed between the first pixel electrode 170a and the common electrode lines 140. When the same scanning signals are loaded on the second gate lines 120b, that is, the second gate lines 120b receive the scanning signals, as the second gate area 161 of the second TFT 160 electrically connects to the second gate lines 120b and the second gate area 161 of the second TFT 160 electrically connects to the second pixel electrode 170b, the scanning signals are loaded on the second pixel electrode 170b via the second TFT 160. At this moment, a second electrical field is formed between the second pixel electrode 170b and the common electrode lines 140. As the number of the display fields of the second pixel electrode 170b is greater than the number of the display fields of the first pixel electrode 170a, the second electrical field is more divergent than the first electrical field. For the reason, when the array substrate 10 is adopted in the LCD, the rotating angle of the liquid crystal molecules within the LCD may be larger, such that the viewing angle of the second viewing angle mode is greater than the viewing angle of the first viewing angle mode. Usually, the first viewing angle mode may also be referred to as a narrow viewing angle mode, and the second viewing angle mode may also be referred to as a wide viewing angle mode. When the condition that the second gate lines 120a receives the scanning signals transitions to the condition that the first gate lines 120b receives the scanning signals, the array substrate 10 transitions from the narrow viewing angle mode to the wide viewing angle mode. At this moment, the viewing angle of the array substrate 10 is wider. When the condition that the second gate lines 120b receives the scanning signals transitions to the condition that the first gate lines 120a receives the scanning signals, the array substrate 10 transitions from the narrow viewing angle mode to the wide viewing angle mode. At this moment, the viewing angle of the array substrate 10 is narrower.

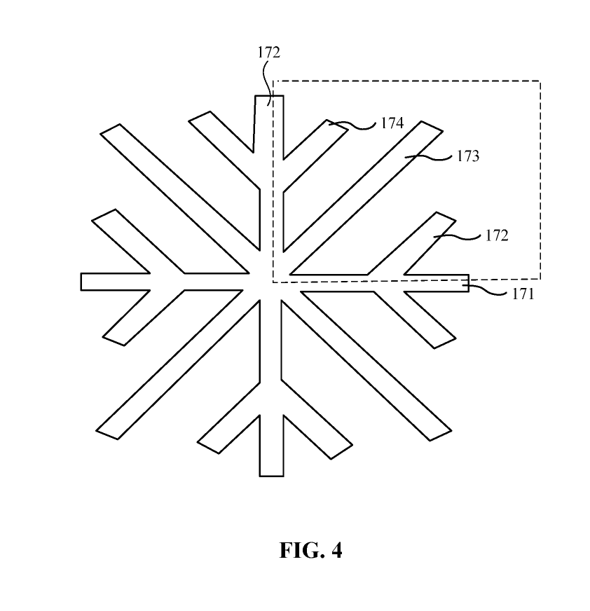

FIG. 4 is a schematic view of the second pixel electrode of FIG. 2. The second pixel electrode 170b includes a first main branch 171 and a second main branch 172, and the second main branch 172 intersects with the first main branch 171 to form four display fields, wherein the dashed rectangle indicates one display field. The second pixel electrode 170b within each of the display fields includes a first sub-branch 173, a second sub-branch 174, and a third sub-branch 175. The first sub-branch 173 extends from the first main branch 171, the second sub-branch 174 extends from an intersection of the first main branch 171 and the first sub-branch 172, and the third sub-branch 175 extends from the first sub-branch 172. In addition, the first sub-branch 173, the second sub-branch 174, and the third sub-branch 175 are parallel to each other, and are spaced apart from each other. In the embodiment, the number of the display field of the 170a the number of the display field of the first pixel electrode 170a is one.

In the embodiment, the first main branch 171 and the first sub-branch 172 are perpendicular to each other and intersect with each other. The intersection is at a middle point of the first main branch 171 and of the first sub-branch 172. The first sub-branch 173 is symmetrical to the third sub-branch 175 with respect to the second sub-branch 174. In addition, the length of the second sub-branch 174 is greater than the length of the first sub-branch 173, and the length of the second sub-branch 174 is greater than the length of the third sub-branch 175. Preferably, the length of the first sub-branch 173 is equal to the length of the third sub-branch 175.

Referring to FIG. 3, the first insulation layer 180a covers the first gate area 151, the second gate area 161, and the common electrode line 140. The first pixel electrode 170a is arranged on the first insulation layer 180a, and the first pixel electrode 170a corresponds to the common electrode line 140. The first TFT 150 further includes a first trench layer 153 and the first drain area 155. The first trench layer 153 is arranged above the first insulation layer 180a, the first trench layer 153 corresponds to the first gate area 151, and the first trench layer 153 and the first pixel electrode 170a are spaced apart from each other. The first source area 154 and the first drain area 155 are arranged at two opposite ends of the first trench layer 153, and the first source area 154 covers a portion of the first pixel electrode 170a. The second insulation layer 180b covers the first source area 154 and the first drain area 155.

The first TFT 150 also includes a first ohmic contact layer 156 arranged between the first source area 154 and the first trench layer 153. The first ohmic contact layer 156 is configured for reducing the contacting resistance between the first source area 154 and the first trench layer 153.

The first ohmic contact layer 156 further includes a second ohmic contact layer 157 arranged between the first drain area and the first trench layer 153. The second ohmic contact layer 157 is configured for reducing the contacting resistance between the first drain area 155 and the first trench layer 153. It can be understood that the first TFT 150 may only include the first ohmic contact layer 156 or the second ohmic contact layer 157. Alternatively, the first TFT 150 may include the first ohmic contact layer 156 and the second ohmic contact layer 157.

The second TFT 160 includes a second trench layer 163 and a second source area 164. The second trench layer 163 is arranged on the first insulation layer 180a, and the second trench layer 163 corresponds to the second gate area 161. The second trench layer 163 and the first pixel electrode 170a are spaced apart from each other. The second source area 164 and the second drain area 165 are arranged at two opposite ends of the second trench layer 163. The second drain area 165 and the first pixel electrode 170a are spaced apart from each other. The second insulation layer 180b covers the second source area 164 and the second drain area 165. The second insulation layer 180b includes a through hole 181 corresponding to the second drain area 165, and the second pixel electrode 170b is arranged on the second insulation layer 180b. In addition, the second pixel electrode 170b connects to the second drain area 165 via the through hole 181.

The second TFT 160 further includes a third ohmic contact layer 166 arranged between the second source area 164 and the second trench layer 163. The third ohmic contact layer 166 is configured for reducing the contacting resistance between the second source area 164 and the second trench layer 163.

The second TFT 160 further includes a fourth ohmic contact layer 167 arranged between the second drain area 165 and the second trench layer 163. The fourth ohmic contact layer 167 is configured for reducing the contacting resistance between the second drain area 165 and the second trench layer 163. It can be understood that the second TFT 160 may only include the third ohmic contact layer 166 or the fourth ohmic contact layer 167. Alternatively, the second TFT 160 may include the third ohmic contact layer 166 and the fourth ohmic contact layer 167.

In the embodiment, the first source area 154 and the second drain area 165 connect to the data lines 130 to receive the data signals of the data lines 130.

In the embodiment, the substrate 110 may be a transparent insulation substrate including, but not limited to, a glass substrate or a plastic substrate.

The first gate lines 120a, the second gate lines 120b, and the common electrode line 140 may be formed by the method below. A first metal layer is arranged on a first surface 111a of the substrate 110. The first metal layer includes, but not limited to, any one or some of Al, Mo, and Cu. The first metal layer may be formed by Physical Vapor Deposition (PVD). The thickness of the first metal layer may be in a range from 3000 to 6000 angstrom. Afterward, the first metal layer is patterned to form the 120a, the second gate lines 120b, and the common electrode lines 140. The pattern of the first metal layer may be formed by exposure, development, etching, or stripping via a mask.

The first insulation layer 180a may be formed by Plasma Enhanced Chemical Vapor Deposition (PECVD) to deposit an insulation layer having a thickness in a range from 2000 to 5000 angstroms. The insulation layer may be, but not limited to, SiNx.

The first trench layer 153, the second trench layer 163, the first ohmic contact layer 156, the second ohmic contact layer 157, the third ohmic contact layer 166, and the fourth ohmic contact layer 167 may be made by the methods below. First, an a-si layer is deposited on the first insulation layer 180a via PECVD, the thickness of the a-si layer is in a range from 1500 to 3000 angstroms. The patterning process is then applied to the a-si layer to maintain the portion of the a-si layer corresponding to the first gate area 151 and corresponding to the second gate area 161. To simply the descriptions, the portion of the a-si layer corresponding to the first gate area 151 is referred to as a first a-si portion, and the portion of the a-si layer corresponding to the second gate area 161 is referred to as a second a-si portion. An ion-doping process is applied to two ends of the first a-si portion to form the first ohmic contact layer 156 and the second ohmic contact layer 157, and the area of the first a-si portion that has not been applied with the ion-doping is the first trench layer 153. The ion-doping process is applied to two ends of the second a-si portion to form the third ohmic contact layer 166 and the fourth ohmic contact layer 167, and the area of the second a-si portion that has not been applied with the ion-doping is the second trench layer 163. In one embodiment, the ion doping process relates to N-type ion-doping.

The first source area 154, the first drain area 155, the second source area 164, and the second drain area 165 may be formed by the method below. A second metal layer is formed. The second metal layer includes any one or some of the Al, Mo, and Cu. The second metal layer may be formed by PVD. The thickness of the second metal layer may be in a range from 3000 to 6000 angstrom. Afterward, the second metal layer is patterned to form the first source area 154, the first drain area 155, the second source area 164, and the second drain area 165. The pattern of the second metal layer may be formed by exposure, development, etching, or stripping via a mask.

The second insulation layer 180b may be formed by PECVD to deposit an insulation layer having a thickness in a range from 2000 to 5000 angstroms. The insulation layer may be, but not limited to, SiNx. The through hole 181 of the second may be formed by exposure, development, etching, or stripping via a mask.

The first pixel electrode 170a and the second pixel electrode may be formed by the method below. The PVD method is adopted to deposit transparent conductive material having the thickness in a range from 400 to 1000 angstroms. Afterward, the exposure, development, etching, or stripping process is adopted with the mask. The transparent conductive material may be, but not limited to, Indium Tin Oxide (ITO).

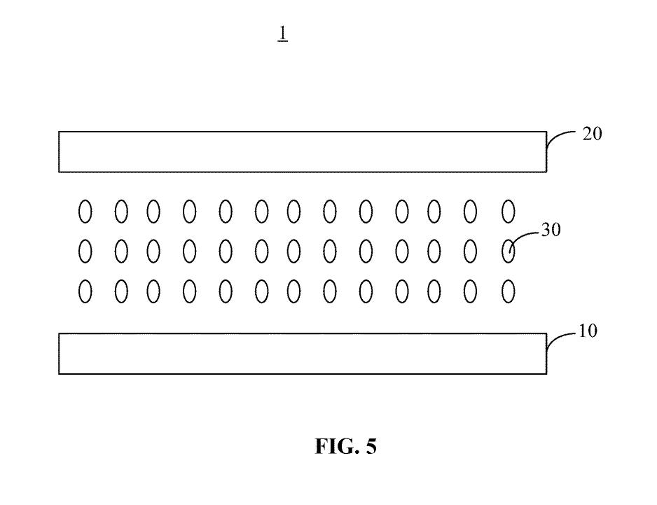

The present disclosure also relates to a liquid crystal panel. FIG. 5 is a schematic view of the liquid crystal panel in accordance with one embodiment. The liquid crystal panel 1 includes an array substrate 10, a CF substrate 20, and a liquid crystal layer 30. The array substrate 10 is opposite to the CF substrate 20, and the array substrate 10 and the CF substrate 20 are spaced apart from each other. The liquid crystal layer 30 is arranged between the array substrate 10 and the CF substrate 20. The array substrate 10 may be the array substrates in the above.

In view of the above, the array substrate 10 includes a plurality of first gate lines 120a and a plurality of second gate lines 120b. Each of the second gate lines 120b is arranged between two adjacent first gate lines 120a. The adjacent first gate lines 120a and the second gate lines 120b, and two adjacent data lines 130 cooperatively define one pixel area. On the array substrate 10, the first gate lines 120a, the second gate lines 120b, and the data lines 130 forms a plurality of pixel areas arranged in a matrix. Each of the pixel areas includes the first TFT 150 corresponding to the first gate lines 120a and a first pixel electrode 170a, and each of the pixel areas includes the second TFT 160 corresponding to the second gate lines 120b and the second pixel electrode 170b. The number of the display fields of the second pixel electrode 170b is greater than the number of the display fields of the first pixel electrode 170a. When the condition that the first gate lines 120a receive the scanning signals transitions to the condition that the second gate lines 120b receive the scanning signals, the array substrate 10 transitions from a first viewing angle mode to a second viewing angle mode. When the condition that the second gate lines 120b receives the scanning signals transitions to the condition that the first gate lines 120a receives the scanning signals, the array substrate 10 transitions from the second viewing angle mode to the first viewing angle mode, wherein the viewing angle of the first viewing angle mode is smaller than that of the second viewing angle mode. In this way, the two viewing angle modes are transitions to each other.

Above are embodiments of the present invention, which does not limit the scope of the present invention. Any modifications, equivalent replacements or improvements within the spirit and principles of the embodiment described above should be covered by the protected scope of the invention.

What is claimed is:

1. An array substrate, comprising:
a substrate and a plurality of first gate lines, a plurality of second gate lines, and a plurality of data lines arranged on the same side of the substrate, the substrate comprises a first surface, and the first gate lines are arranged on the first surface, the first gate lines extend along a first direction and spaced apart from each other along a second direction, the second gate lines are arranged on the first surface, the second gate lines extend along the first direction, and are spaced apart from each other along the second direction, each of the second gate lines is arranged between two adjacent first gate lines, the array substrate further comprises a plurality of common electrode lines on the first surface, each of the common electrode lines is arranged between adjacent first gate lines and the second gate lines, the adjacent first gate lines and the second gate lines, and two adjacent data lines cooperatively define one pixel area;
the array substrate further comprises a first pixel electrode, a second pixel electrode, a first TFT, and a second TFT, the first pixel electrode is isolated from the common electrode lines by a first insulation layer, and the second pixel electrode is isolated from the first pixel electrode by a second insulation layer, a number of the display fields of the second pixel electrode is greater than the number of the display fields of the first pixel electrode, the first gate lines is arranged in the pixel area formed in a rim of the first TFT, the first TFT comprises a first gate area and a first source area, the first gate area electrically connects to the first gate lines forming the pixel area, the first source area electrically connects to the first pixel electrode, the second gate lines is arranged in the pixel area formed in the rim of the second TFT, the second TFT comprises a second gate area and a second drain area, the second gate area electrically connects to the second gate line forming the pixel area, and the second drain area electrically connects to the second pixel electrode, when a condition that the first gate lines receive the scanning signals transitions to the condition that the second gate lines receive the scanning signals, the array substrate transitions from a first viewing angle mode to a second viewing angle mode, when the condition that the second gate lines receives the scanning signals transitions to the condition that the first gate lines receives the scanning signals, the array substrate transitions from the second viewing angle mode to the first viewing angle mode, wherein the viewing angle of the first viewing angle mode is smaller than that of the second viewing angle mode.

2. The array substrate as claimed in claim 1, wherein the second pixel electrode comprises a first main branch and a second main branch, and the second main branch intersects with the first main branch to form four display fields, the second pixel electrode within each of the display fields comprises a first sub-branch, a second sub-branch, and a third sub-branch, the first sub-branch extends from the first main branch, the second sub-branch extends from an intersection of the first main branch and the first sub-branch, and the third sub-branch extends from the first sub-branch, and the first sub-branch, the second sub-branch, and the third sub-branch are parallel to each other, and are spaced apart from each other.

3. The array substrate as claimed in claim 2, wherein the first main branch and the first sub-branch are perpendicular to each other and intersect with each other, the intersection is at a middle point of the first main branch and of the first sub-branch, the first sub-branch is symmetrical to the third sub-branch with respect to the second sub-branch, a length of the second sub-branch is greater than the length of the first sub-branch, and the length of the second sub-branch is greater than the length of the third sub-branch.

4. The array substrate as claimed in claim 1, wherein the first insulation layer covers the first gate area, the second gate area, and the common electrode line, the first pixel electrode is arranged on the first insulation layer, and the first pixel electrode corresponds to the common electrode line, the first TFT further comprises a first trench layer and the first drain area, the first trench layer is arranged above the first insulation layer, the first trench layer corresponds to the first gate area, and the first trench layer and the first pixel electrode are spaced apart from each other, the first source area and the first drain area are arranged at two opposite ends of the first trench layer, and the first source area covers a portion of the first pixel electrode, and the second insulation layer covers the first source area and the first drain area.

5. The array substrate as claimed in claim 4, wherein the first TFT also comprises a first ohmic contact layer arranged between the first source area and the first trench layer, and the first ohmic contact layer is configured for reducing the contacting resistance between the first source area and the first trench layer.

6. The array substrate as claimed in claim 4, wherein the first ohmic contact layer further comprises a second ohmic contact layer arranged between the first drain area and the first trench layer, the second ohmic contact layer is configured for reducing the contacting resistance between the first drain area and the first trench layer.

7. The array substrate as claimed in claim 4, wherein the second TFT comprises a second trench layer and a second source area, the second trench layer is arranged on the first insulation layer, and the second trench layer corresponds to the second gate area, the second trench layer and the first pixel electrode are spaced apart from each other, the second source area and the second drain area are arranged at two opposite ends of the second trench layer, the second drain area and the first pixel electrode are spaced apart from each other, the second insulation layer covers the second source area and the second drain area, the second insulation layer comprises a through hole corresponding to the second drain area, and the second pixel electrode is arranged on the second insulation layer, and the second pixel electrode connects to the second drain area via the through hole.

8. The array substrate as claimed in claim 7, wherein the second TFT further comprises a third ohmic contact layer arranged between the second source area and the second trench layer, and the third ohmic contact layer is configured for reducing the contacting resistance between the second source area and the second trench layer.

9. The array substrate as claimed in claim 7, wherein the second TFT further comprises a fourth ohmic contact layer arranged between the second drain area and the second trench layer, and the fourth ohmic contact layer is configured for reducing the contacting resistance between the second drain area and the second trench layer.

10. A liquid crystal panel, comprising:
an array substrate comprising a substrate and a plurality of first gate lines, a plurality of second gate lines, and a plurality of data lines arranged on the same side of the substrate, the substrate comprises a first surface, and the first gate lines are arranged on the first surface, the first gate lines extend along a first direction and spaced apart from each other along a second direction, the second gate lines are arranged on the first surface, the second gate lines extend along the first direction, and are spaced apart from each other along the second direction, each of the second gate lines is arranged between two adjacent first gate lines, the array substrate further comprises a plurality of common electrode lines on the first surface, each of the common electrode lines is arranged between adjacent first gate lines and the second gate lines, the adjacent first gate lines and the second gate lines, and two adjacent data lines cooperatively define one pixel area;
the array substrate further comprises a first pixel electrode, a second pixel electrode, a first TFT, and a second TFT, the first pixel electrode is isolated from the common electrode lines by a first insulation layer, and the second pixel electrode is isolated from the first pixel electrode by a second insulation layer, a number of the display fields of the second pixel electrode is greater than the number of the display fields of the first pixel electrode, the first gate lines is arranged in the pixel area formed in a rim of the first TFT. The first TFT comprises a first gate area and a first source area, the first gate area electrically connects to the first gate lines forming the pixel area, the first source area electrically connects to the first pixel electrode, the second gate lines is arranged in the pixel area formed in the rim of the second TFT, the second TFT comprises a second gate area and a second drain area, the second gate area electrically connects to the second gate line forming the pixel area, and the second drain area electrically connects to the second pixel electrode, when a condition that the first gate lines receive the scanning signals transitions to the condition that the second gate lines receive the scanning signals, the array substrate transitions from a first viewing angle mode to a second viewing angle mode, when the condition that the second gate lines receives the scanning signals transitions to the condition that the first gate lines receives the scanning signals, the array substrate transitions from the second viewing angle mode to the first viewing angle mode, wherein the viewing angle of the first viewing angle mode is smaller than that of the second viewing angle mode.

11. The liquid crystal panel as claimed in claim 10, wherein the second pixel electrode comprises a first main branch and a second main branch, and the second main branch intersects with the first main branch to form four display fields, the second pixel electrode within each of the display fields comprises a first sub-branch, a second sub-branch, and a third sub-branch, the first sub-branch extends from the first main branch, the second sub-branch extends from an intersection of the first main branch and the first sub-branch, and the third sub-branch extends from the first sub-branch, and the first sub-branch, the second sub-branch, and the third sub-branch are parallel to each other, and are spaced apart from each other.

12. The liquid crystal panel as claimed in claim 11, wherein the first main branch and the first sub-branch are perpendicular to each other and intersect with each other, the intersection is at a middle point of the first main branch and of the first sub-branch, the first sub-branch is symmetrical to the third sub-branch with respect to the second sub-branch, a length of the second sub-branch is greater than the length of the first sub-branch, and the length of the second sub-branch is greater than the length of the third sub-branch.

13. The liquid crystal panel as claimed in claim 10, wherein the first insulation layer covers the first gate area, the second gate area, and the common electrode line, the first pixel electrode is arranged on the first insulation layer, and the first pixel electrode corresponds to the common electrode line, the first TFT further comprises a first trench layer and the first drain area, the first trench layer is arranged above the first insulation layer, the first trench layer corresponds to the first gate area, and the first trench layer and the first pixel electrode are spaced apart from each other, the first source area and the first drain area are arranged at two opposite ends of the first trench layer, and the first source area covers a portion of the first pixel electrode, and the second insulation layer covers the first source area and the first drain area.

14. The liquid crystal panel as claimed in claim 13, wherein the first TFT also comprises a first ohmic contact layer arranged between the first source area and the first trench layer, and the first ohmic contact layer is configured for reducing the contacting resistance between the first source area and the first trench layer.

15. The liquid crystal panel as claimed in claim 13, wherein the first ohmic contact layer further comprises a second ohmic contact layer arranged between the first drain area and the first trench layer, the second ohmic contact layer is configured for reducing the contacting resistance between the first drain area and the first trench layer.

16. The liquid crystal panel as claimed in claim 13, wherein the second TFT comprises a second trench layer and a second source area, the second trench layer is arranged on the first insulation layer, and the second trench layer corresponds to the second gate area, the second trench layer and the first pixel electrode are spaced apart from each other, the second source area and the second drain area are arranged at two opposite ends of the second trench layer, the second drain area and the first pixel electrode are spaced apart from each other, the second insulation layer covers the second source area and the second drain area, the second insulation layer comprises a through hole corresponding to the second drain area, and the second pixel electrode is arranged on the second insulation layer, and the second pixel electrode connects to the second drain area via the through hole.

17. The liquid crystal panel as claimed in claim 16, wherein the second TFT further comprises a third ohmic contact layer arranged between the second source area and the second trench layer, and the third ohmic contact layer is configured for reducing the contacting resistance between the second source area and the second trench layer.

18. The liquid crystal panel as claimed in claim 16, wherein the second TFT further comprises a fourth ohmic contact layer arranged between the second drain area and the second trench layer, and the fourth ohmic contact layer is configured for reducing the contacting resistance between the second drain area and the second trench layer.
